(19) United States
(12) Patent Application Publication
(10) Pub. No.: US 2019/0070886 A1
(43) Pub. Date: Mar. 7, 2019

(54) Pull-Apart Gift Card Holder

(71) Applicant: American Greetings Corporation, Cleveland, OH (US)

(72) Inventor: Gary Nelson, Avon, OH (US)

(21) Appl. No.: 15/913,461

(22) Filed: Mar. 6, 2018

Related U.S. Application Data
(63) Continuation-in-part of application No. 15/698,387, filed on Sep. 7, 2017.

(51) Int. Cl. B42D 15/04; B65D 77/20; B65D 81/36; G09F 1/08

(52) U.S. Cl. CPC B42D 15/045; B65D 77/20; B42D 25/285; G09F 1/08; B65D 81/365

(57) ABSTRACT

A gift card holder which is a single unit having a gift card retainer for holding a gift card therein and an outer body containing two separate pieces which are slidably engaged with the gift card retainer. The two portions of the outer body of the gift card holder can be in a first position wherein they are flush with each other along at least one edge and wherein the gift card retainer is concealed therein. The two portions of the outer body of the gift card holder can move from the first position to a second position wherein the two portions are pulled in opposing directions away from each other, thereby revealing the gift card retainer (and gift card contained therein).

### RELATED APPLICATIONS

This application is a continuation-in-part of and claims priority to U.S. patent application Ser. No. 15/698,387 for “Themed Gift Card and Gift Card Holder Combinations and Packaging Therefor”, filed on Sep. 7, 2017.

### FIELD OF THE INVENTION

The present invention is in the field of social expression products. More specifically, the invention is directed to a construct for retaining a gift card inside of a pull-apart gift card holder.

### SUMMARY OF THE INVENTION

In one embodiment, the gift card holder of the present disclosure and related inventions includes an outer body containing a right side and a left side, where the right and left sides are mirror images thereof and a gift card retainer which is contained between the right and left sides of the outer body. The gift card retainer includes a recessed portion which is operative to receive a gift card therein, and an opening or cavity which extends through the entire length of the gift card retainer. The gift card holder is operative to move between a first position wherein the gift card retainer is concealed between the right and left side portions of the outer body and a second position wherein the gift card retainer is visible between the right and left side portions of the outer body.

In another embodiment, the gift card holder contains an outer body containing a right side and a left side and a gift card retainer which is operative to contain a gift card therein. The right and left sides of the outer body are slidably attached to the gift card retainer and the outer body is operative to move between a first position wherein an inside edge of the right and left sides are in contact with each other and a second position wherein the right and left side portions are not in contact with each other. Also, the gift card retainer is concealed between the right and left sides of the outer body in the first position.

In still another embodiment, the gift card holder contains an outer body containing a first half and a second half and a gift card retainer engaged with both the first and second halves of the outer body. The first and second halves of the outer body each contain a graphic thereon which is one half of a complete image. The gift card holder is operative to move between a first position wherein the gift card retainer is concealed between the first and second halves of the outer body and a second position wherein the gift card retainer is visible between the first and second halves of the outer body.

### DESCRIPTION OF THE DRAWINGS

FIG. 1 is a perspective view of one embodiment of the pull-apart gift card holder of the present invention, in a closed position.

FIG. 2 is a perspective view of the pull-apart gift card holder of FIG. 1, in an open position with gift card.

FIG. 3 is a partial tear-away view of the pull-apart gift card holder of FIG. 2.

FIG. 4 is a front exploded view of the pull-apart gift card holder of FIG. 2.

FIG. 5 is a rear exploded view of the pull-art gift card holder of FIG. 2.

FIG. 6 is a close-up view of the engagement between two parts of the gift card holder.

FIG. 7 is a perspective view of a second embodiment of the pull-apart gift card holder of the present invention, in a closed position.

FIG. 8 is a perspective view of the pull-apart gift card holder of FIG. 7, in an open position with gift card.

### DETAILED DESCRIPTION OF PREFERRED AND ALTERNATE EMBODIMENTS

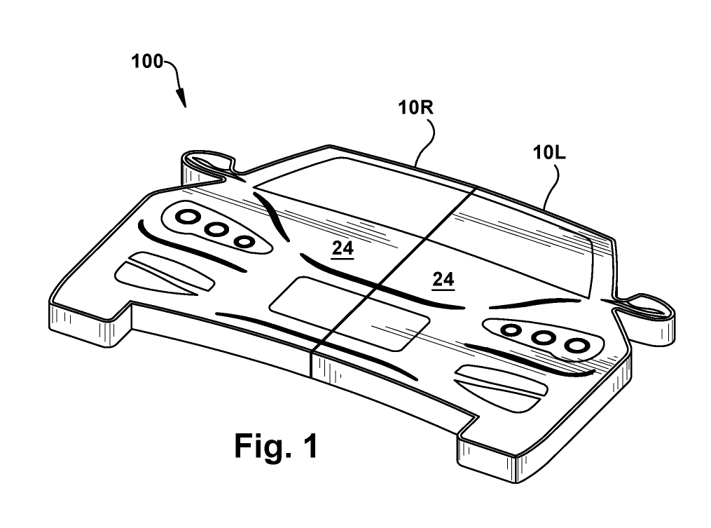

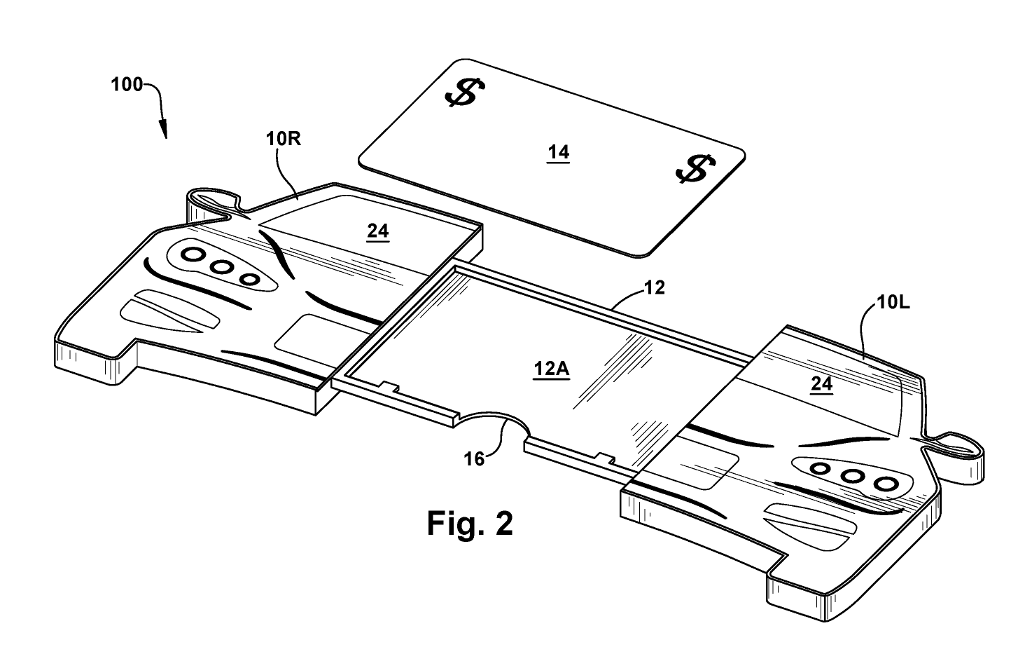

The pull-apart gift card holder (also referred to herein as “gift card holder”) 100 of the present disclosure and related inventions provides a new and surprising way to present a gift card to a recipient. In one embodiment, the gift card holder 100 contains at least three integral pieces, an outer body 10 containing a right and left side portion 10R, 10L and a gift card retainer 12 which is positioned between or inside the outer body 10 or right and left side portions 10R, 10L of the outer body 10. The gift card holder 100 is able to move between a first position, wherein the gift card retainer 12 is concealed between outer body 10 or right and left side portions 10R, 10L of the outer body 10, as shown in FIG. 1, and a second position, wherein the outer body 10 or right and left side portions 10R, 10L of the outer body 10 are pulled apart or in opposing directions, such as to the right and left, revealing the gift card retainer 12, and any gift card 14 contained therein, as shown in FIG. 2. In one embodiment, each piece of the gift card holder is made of plastic, although in other embodiments, other materials may be used.

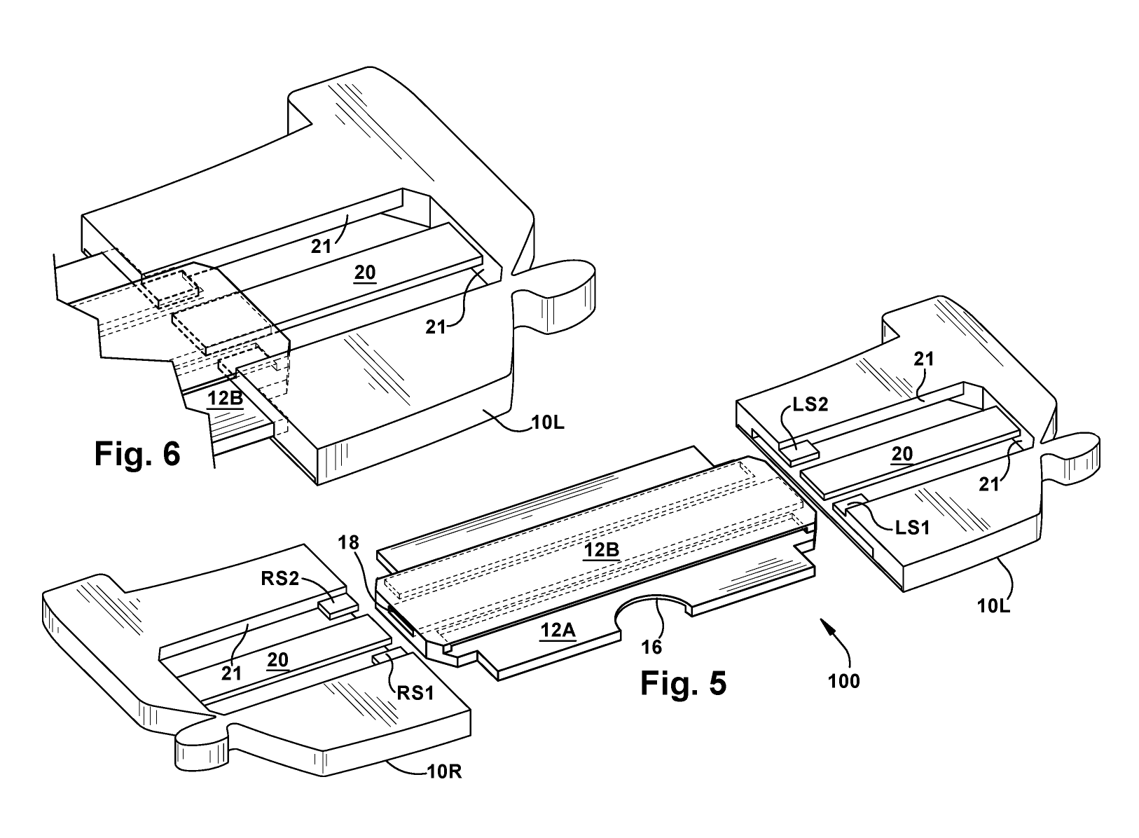

The gift card retainer portion 12 of the pull-apart gift card holder 100 of the present disclosure and related inventions, in one embodiment, includes a gift card receptacle 12A and a backer 12B. The gift card receptacle 12A is substantially rectangular with a sunken area or indentation which accommodates a standard-sized gift card 14. It may also contain, in one embodiment, a half moon-shaped cutout 16 on a lower horizontal edge thereof to accommodate insertion and removal of a gift card therein. The gift card receptacle 12A also contains two minor retaining tabs M1, M2 which extend upward from a bottom horizontal edge thereof which help to retain a gift card within the sunken area or indentation. Two larger tabs or projections RT, LT are integral with the gift card receptacle 12 and extend outward from right and left sides thereof. A right tab RT extends outward from a right vertical edge and a left tab LT extends outward from a left vertical edge. The right and left tabs or projections RT, LT engage with the outer body 10 of the gift card holder 100, as described in greater detail below. The backer portion 12B of the gift card retainer 12 is attached to or integral with a rear surface of the gift card receptacle 12A and is an elongate rectangular strip with a horizontal opening or channel 18 extending therethrough. The backer has a width that is substantially the same as the width of the gift card receptacle 12A (including the right and left side tabs RT, LT) and a height or length which is less than the gift card receptacle 12A. The backer 12B is positioned at the vertical center of the rear surface of the gift card receptacle 12A so that at least a portion of the rear surface of the gift card receptacle 12A can be seen above the backer 12B and at least a portion of the rear surface of the gift card receptacle 12A can be seen below the backer 12B, as shown in FIG. 5. A horizontal opening or channel 18 extends through the entire backer portion 12B of the gift card retainer 12 and facilitates attachment to or engagement with and slide or pull apart movement of the outer body 10 with respect to the gift card retainer portion 12 of the gift card holder 100, as shown in FIG. 6.

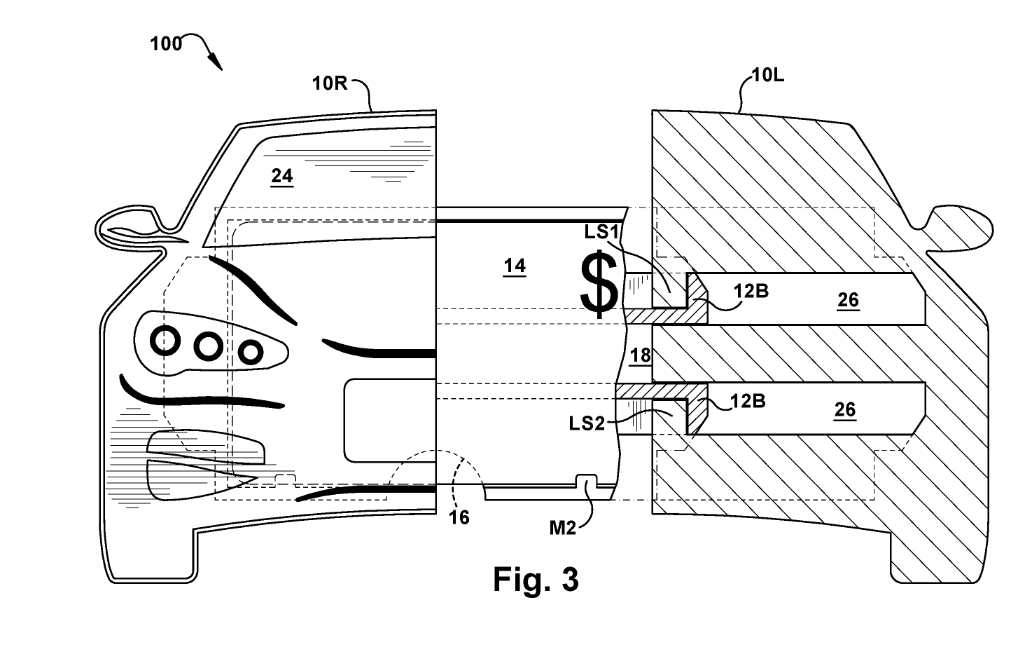

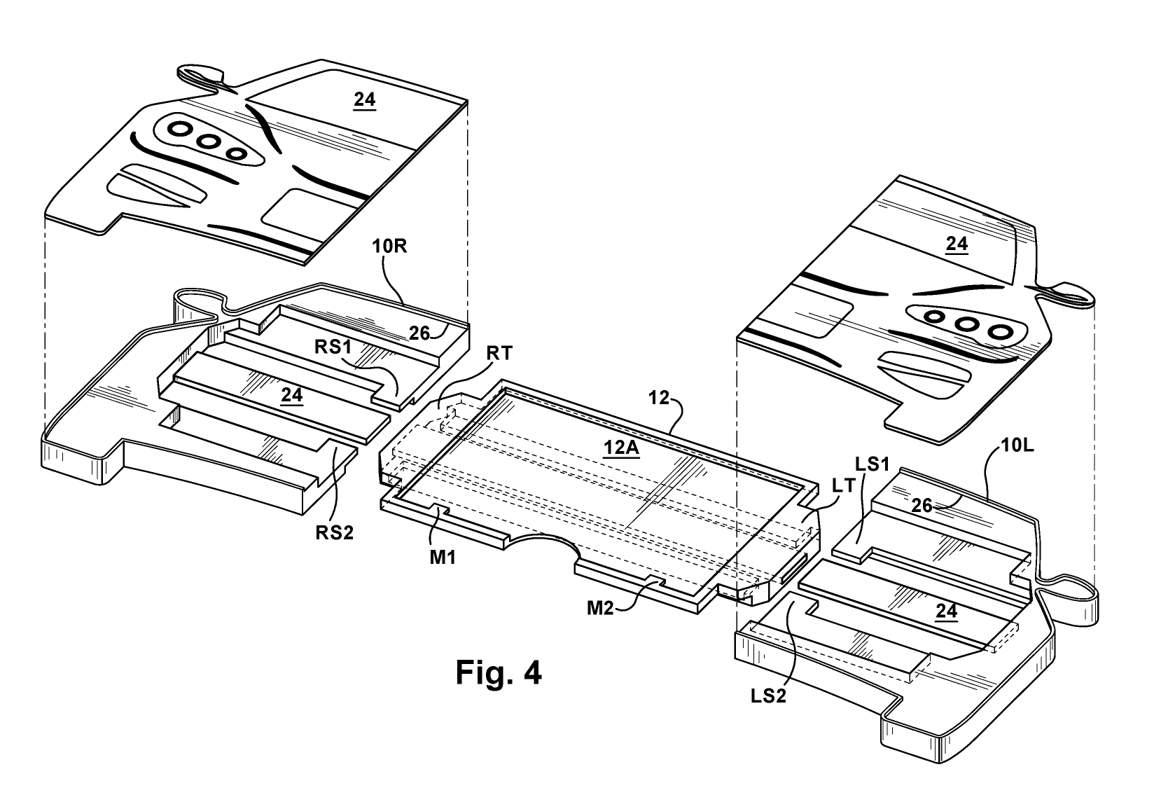

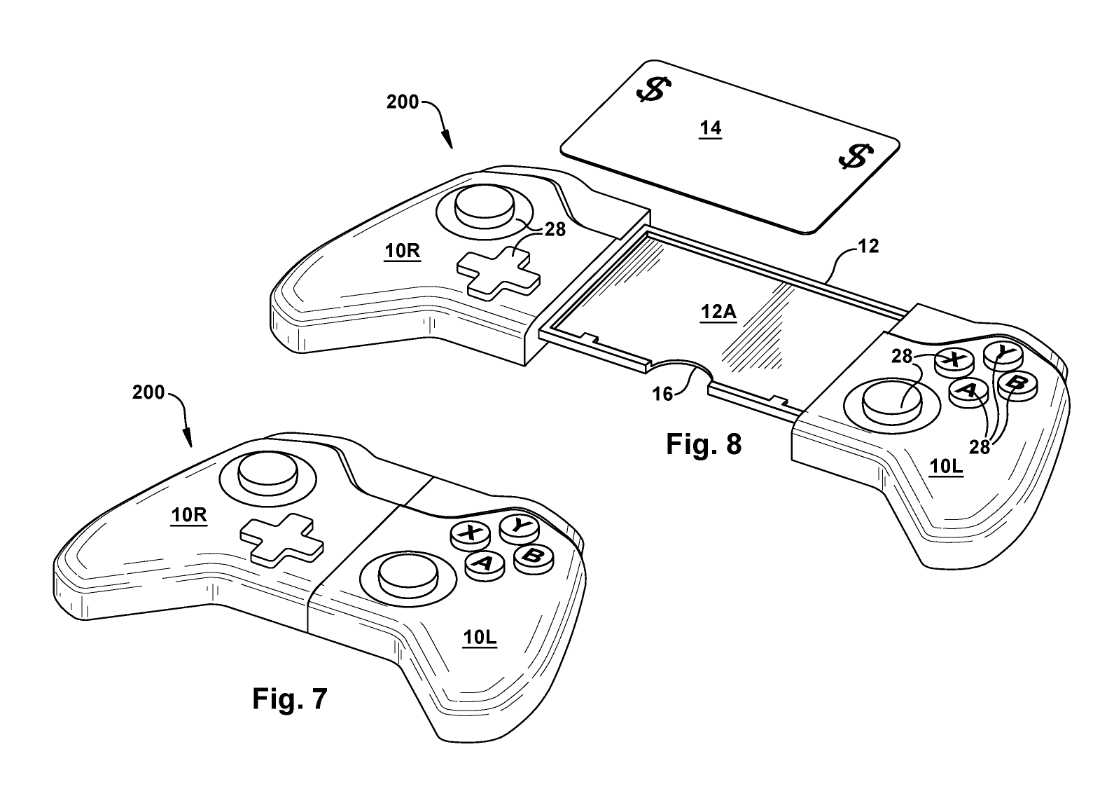

The outer body portion 10 of the gift card holder 100 of the present disclosure and related inventions includes a right side 10R and a left side 10L, which are mirror images of each other. The right and left side portions 10R, 10L of the outer body 10 are separate and distinct from one another but are both attached to or engaged with the gift card retainer portion 12 of the gift card holder 100. The shape of the outer body 12 may be formed to take on any shape, such as the shape of a car or video game controller, as shown in the figures. The outer body 10 of the gift card holder 100 may alternately be fashioned to take on any other conceivable shape. Each of the right and left side portions 10R, 10L of the outer body 10 contain a recessed portion 21 which accommodates attachment to or engagement with the gift card retainer 12. For example, as shown in the figures, each of the right and left side 10R, 10L contain a recessed portion 21 which takes the shape of one half of the gift card retainer 12, including the outer rectangular shape with the right or left side tab portion attached to or integral with the right and left vertical sides RT, LT of the gift card retainer 12, as shown in FIGS. 5 and 6. Also, within the recessed portion 21 of each of the right and left sides of the outer body 10, is a slat, tongue, or substantially rectangular elongate projection 20 (hereinafter referred to as “slat”) extending horizontally into the recessed portion. These slats 20 engage with the horizontal opening or channel 18 which extend through the backer portion 12B of the gift card retainer portion 12 of the gift card holder 100. The length of each slat 20 is approximately equal to half the length of the horizontal opening or channel 18 in the backer portion 12B of the gift card retainer 12 so that when each of the slats 20 is fully inserted into the horizontal opening or channel 18, the inner edges of the right and left side portions 10R, 10L of the outer body 10 of the gift card holder 100 sit flush against each other, as shown in FIG. 1. This first position (closed position), shown in FIG. 1, wherein the slats 20 contained on the right and left side portions 10R, 10L of the outer body 10 of the gift card holder 100 are fully inserted into the horizontal opening or channel 18 through the gift card retainer 12 portion of the gift card holder 100, fully conceals the gift card retainer 12. A second position (open position), shown in FIG. 2, wherein the slats 20 are substantially removed from the horizontal opening or channel 18, such as by pulling or sliding the right and left side portions 10R, 10L of the outer body 10 of the gift card holder 100 in opposing directions, reveals the gift card retainer 12 and any gift card 14 contained therein. The right and left side portions 10R, 10L of the outer body 10 are freely moveable between the first and second positions. In one embodiment, the right and left side portions 10R, 10L of the outer body 10 contain two stopper tabs, a first stopper tab RS1 or LS1 projecting downward from an upper portion of the right and left side portions 10R, 10L of the outer body 10 of the gift card holder 100 and a second stopper tab RS2 or LS2 projecting upward from a bottom portion of the right and left side portions 10R, 10L of the outer body 10 of the gift card holder 100, as shown in FIG. 5. Each stopper tab RS1, RS2, LS1, LS2 engages with the backer portion 12B of the gift card retainer 12 to prevent the complete removal of the right and left side portions 10R, 10L of the gift card holder 100 from the gift card retainer portion 12 of the gift card holder, as shown in FIG. 3. In one embodiment, a front face of the outer body 10 of the gift card holder 100 contains a slight indentation 26 to accommodate a graphics panel 24, which in one embodiment, may be a paperboard insert 24 is shaped, such as for example, a car, as shown in FIG. 4. The graphics panels 24 are in the exact shape of the outer body 10 of the gift card holder 100 and contain two completely separate and distinct pieces, one of which is inserted into the right side portion 10R of the outer body 10 of the gift card holder 100 and the other which is inserted into the left side portion 10L of the outer body 10 of the gift card holder 100. When the gift card holder 100 is in the first position, with the inside edges of the right and left side portions 10R, 10L sitting flush against each other, as shown in FIG. 1, the graphics on each graphics panel 24 combine to form a complete picture, such as for example, the car, as shown in the FIG. 1. The graphics panel 24 may be glued onto the front surface of the right and left side portions 10R, 10L of the outer body 10 of the gift card holder 100 or any other attachment mechanism may be used. The graphics panel 24 may additionally contain text sentiment or other printing thereon similar to items printed on a greeting card. The shape of the gift card holder 100 and content of the graphics panel 24 may also be themed or have a theme which is related to a gift card 14 contained therein, wherein, for one example, the shape of the gift card holder 100 and content of the graphics panel 24 may depict a sandwich and the gift card 14 is for a sandwich shop. In another embodiment, shown in FIGS. 7 and 8, instead of having the graphics panels 24, the right and left side portions 10R, 10L of the outer body 10 of the gift card holder 100 are molded to contain more realistic and three-dimensional features, such as, for example, a video game controller may be shaped and molded to resemble an actual video game controller, with curved or rounded edges and raised faux buttons and controls 28. The gift card holder itself would resemble or look like the actual object, such as with the video game controller shown in FIGS. 7 and 8. Regardless of whether an embodiment uses graphics panels 24 or raised, molded features, the internal an operational and internal aspects of the gift card holder 100 remain the same.

While the gift card holder of the present invention and related disclosure is described herein as being made of certain materials, such as plastic and paperboard, other materials may be used and are considered to be within the scope of the invention. Sizes and shapes of each piece of the gift card holder may also be altered, for example, as noted above, the gift card holder may be shaped like an animate object, such as a car, a video game controller, or any conceivable shape. While the size of a standard gift card has been given as an example size for the gift card retainer, other sizes may be implemented while remaining within the scope of the present invention. Also, the gift card retainer may alternatively be used to retain money, a note card, a greeting card, a gift certificate or other such gift item. The example described herein and shown in the drawings opens by moving right and left sides of the outer body in opposing directions, however, in other embodiments, instead of being configured next to each other, as right and left side portions, the outer body may contain upper and lower portions which are arranged vertically and open by pulling the upper and lower portions in opposing directions, such as up and down. In alternate embodiments, the gift card holder may additionally contain a sound module which is operative to store and playback at least one audio file which is triggered upon moving the two portions of the outer body of the gift card holder from the first to second positions.

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated. It is intended that the invention be defined by the following claims.

1. A gift card holder comprising:
an outer body containing a right side and a left side, the right and left sides being a mirror images thereof;
a gift card retainer contained between the right and left sides of the outer body, the gift card retainer comprising a recessed portion operative to receive a gift card therein, and an opening or cavity which extends through the entire length of the gift card retainer;
wherein the gift card holder is operative to move between a first position wherein the gift card retainer is concealed between the right and left side portions of the outer body and a second position wherein the gift card retainer is visible between the right and left side portions of the outer body.

2. The gift card holder of claim 1, wherein the right and left side portions of the outer body each contain a slat or projection which is slidably inserted into and out of the opening or cavity which extends through the gift card retainer.

3. The gift card holder of claim 1 further comprising a gift card contained within the gift card retainer.

4. The gift card holder of claim 1, wherein the right and left sides of the outer body include a graphics insert attached to a front surface thereof.

5. The gift card holder of claim 1, wherein the right and left sides of the outer body are not completely removable from the gift card retainer.

6. The gift card holder of claim 1, wherein the gift card retainer contains at least two retaining tabs thereon.

7. The gift card holder of claim 1, wherein the gift card holder is made of plastic.

8. A gift card holder comprising:
an outer body containing a right side and a left side;
a gift card retainer operative to contain a gift card therein;
wherein the right and left sides of the outer body are slidably attached to the gift card retainer;
wherein the outer body is operative to move between a first position wherein an inside edge of the right and left sides are in contact with each other and a second position wherein the right and left side portions are not in contact with each other; and
wherein the gift card retainer is concealed between the right and left sides of the outer body in the first position.

9. The gift card holder of claim 8, wherein the right and left sides of the outer body are mirror images of each other.

10. The gift card holder of claim 8, wherein when right and left sides of the outer body contain graphics thereon.

11. The gift card holder of claim 8, wherein the graphics contained on the right and left sides each contain half of a full image.

12. The gift card holder of claim 10, wherein when the outer body is in the first position, the graphics on the right and left sides together create a complete image.

13. The gift card holder of claim 8, wherein the right and left sides of the outer body are only connected via the gift card retainer.

14. A gift card holder comprising:
an outer body containing a first half and a second half;
a gift card retainer engaged with both the first and second halves of the outer body;
wherein the first and second halves of the outer body each contain a graphic thereon which is one half of a complete image;
wherein the gift card holder is operative to move between a first position wherein the gift card retainer is concealed between the first and second halves of the outer body and a second position wherein the gift card retainer is visible between the first and second halves of the outer body.

15. The gift card holder of claim 14, wherein when the gift card holder is in the first position, the graphics on the first and second halves of the outer body create a full image.

16. The gift card holder of claim 14, wherein when the gift card holder is in the first position, at least a portion of the first and second halves are flush with each other.

17. The gift card holder of claim 14, wherein the first and second halves of the outer body are shaped like one half of a car.

18. The gift card holder of claim 14, wherein the first and second halves of the outer body are shaped like one half of a game controller.

19. The gift card holder of claim 14 further comprising a gift card contained within the gift card retainer.

20. The gift card holder of claim 14, wherein the first and second halves of the outer body are shaped as mirror images of each other.
